(19) United States
(12) Patent Application Publication
(10) Pub. No.: US 2024/0377267 A1
(43) Pub. Date: Nov. 14, 2024

(54) LOAD DETECTION DEVICE

(71) Applicant: Japan Display Inc., Tokyo (JP)

(72) Inventor: Hiroumi KINJO, Tokyo (JP)

(21) Appl. No.: 18/657,982

(22) Filed: May 8, 2024

(30) Foreign Application Priority Data
May 9, 2023 (JP) 2023-077427

(51) Int. Cl. G01L 1/20

(52) U.S. Cl. CPC G01L 1/205

(57) ABSTRACT

A load detection device includes a force detector and an elastic deformation part disposed in order in a first direction. The force detector includes an array substrate provided with a plurality of array electrodes on a first surface facing the first direction, and a sensor layer facing the array electrodes.

### CROSS-REFERENCE TO RELATED APPLICATION

This application claims the benefit of priority from Japanese Patent Application No. 2023-077427 filed on May 9, 2023, the entire contents of which are incorporated herein by reference.

### BACKGROUND

### 1. Technical Field

The present disclosure relates to a load detection device.

### 2. Description of the Related Art

Load detection devices are devices that detect a load (force) perpendicularly acting on a detection surface and a load in a direction parallel to the detection surface. The direction perpendicular to the detection surface is hereinafter simply referred to as a vertical direction. The direction parallel to the detection surface is referred to as a horizontal direction. The load detection device according to Japanese Patent Application Laid-open Publication No. 2018-200281 (JP-A-2018-200281) includes a force detector that detects force and an elastic deformation part stacked on the force detector. The force detector includes an array substrate provided with a plurality of array electrodes and a sensor layer facing the array electrodes. The elastic deformation part includes a plurality of protrusions (bumps). The bottom surface of the protrusion is fixed to the force detector, and a load is applied to the top end of the protrusion. One protrusion is disposed over a plurality of array electrodes.

When a load in the horizontal direction is applied to the top end of the protrusion, the top end of the protrusion moves in the direction of the force. As a result, shear stress is generated in the protrusion. The shear stress causes a bias in the force acting on the force detector from the bottom surface of the protrusion in the bottom surface. In other words, more load acts on the part of the bottom surface positioned in the direction in which the load in the horizontal direction acts. Therefore, different force values are detected between the array electrodes over which the protrusion extends, and the direction of the load is identified based on the different force values.

The protrusion described in JP-A-2018-200281 has a trapezoidal sectional shape along the vertical direction. In other words, the width of the protrusion in the horizontal direction decreases from the bottom surface toward the top end. In the load detection device described in JP-A-2018-200281, a plurality of protrusions are adjacently disposed in the horizontal direction. In other words, the bases of the protrusions (ends on the bottom surface side) are continuous in the horizontal direction. Therefore, a gap is formed between the top ends of the protrusions.

There has recently been a demand to make the sectional shape of the protrusion rectangular (including oblong and square). If protrusions with a rectangular sectional shape are disposed as described in JP-A-2018-200281, the top end of the protrusion comes into contact with the top ends of the adjacent protrusions with no gap interposed therebetween. This structure prevents the top end of the protrusion from moving in the horizontal direction if a load in the horizontal direction is applied thereto, and the load in the horizontal direction fails to be detected. To address this, it is desired to develop a load detection device that can detect a load in the horizontal direction if the sectional shape of the protrusion is rectangular.

### SUMMARY

An object of the present disclosure is to provide a load detection device that can detect a load in the horizontal direction if the sectional shape of a protrusion is rectangular.

A load detection device according to a first embodiment of the present disclosure includes a force detector and an elastic deformation part disposed in order in a first direction. The force detector includes an array substrate provided with a plurality of array electrodes on a first surface facing the first direction, and a sensor layer facing the array electrodes. The array electrodes are arrayed in a second direction intersecting the first direction and a third direction intersecting both the first direction and the second direction, the elastic deformation part includes a plurality of protrusions having a rectangular sectional shape along the first direction and arrayed in the second direction and the third direction, the protrusions are each disposed to overlap at least two or more of the array electrodes arrayed in the second direction and at least two or more of the array electrodes arrayed in the third direction when viewed from the first direction, and the protrusions are each spaced apart from the other protrusions disposed in the second direction and the third direction.

A load detection device according to a second embodiment of the present disclosure includes a force detector and an elastic deformation part disposed in order in a first direction. The force detector includes an array substrate provided with a plurality of array electrodes on a first surface facing the first direction, and a sensor layer facing the array electrodes. The array electrodes are arrayed in a second direction intersecting the first direction and a third direction intersecting both the first direction and the second direction, the elastic deformation part includes a plurality of first walls extending in the second direction and arrayed in the third direction, and a plurality of second walls extending in the third direction and arrayed in the second direction, the elastic deformation part has a grid shape by the first walls and the second walls intersecting each other, a portion where the first wall and the second wall intersect is an intersection, a portion of the first wall positioned between the intersections is a first protruding portion, a portion of the second wall positioned between the intersections is a second protruding portion, the first protruding portion has a rectangular sectional shape taken along a virtual plane extending in the first direction and the third direction and is disposed to overlap at least two or more of the array electrodes arrayed in the third direction when viewed from the first direction, the second protruding portion has a rectangular sectional shape taken along a virtual plane extending in the first direction and the second direction and is disposed to overlap at least two or more of the array electrodes arrayed in the second direction when viewed from the first direction, the first protruding portion is spaced apart from the other first protruding portions disposed in the third direction, and the second protruding portion is spaced apart from the other second protruding portions disposed in the second direction.

### BRIEF DESCRIPTION OF THE DRAWINGS

FIG. 1 is a perspective view schematically illustrating a load detection device according to a first embodiment;

FIG. 2 is a sectional view taken along line II-II of FIG. 1 and viewed from the arrow direction;

FIG. 3 is a circuit diagram of a circuit configuration of a force sensor according to the first embodiment;

FIG. 4 is a sectional view taken along line IV-IV of FIG. 1 and viewed from the arrow direction;

FIG. 5 is a schematic of the correspondence between a protrusion and individual detection regions according to the first embodiment;

FIG. 6 is a sectional view of a state where force (load in a force direction) is applied to the protrusion according to the first embodiment;

FIG. 7 is a sectional view of a state where a load in the horizontal direction is applied to the protrusion according to the first embodiment;

FIG. 8 is a schematic of an elastic deformation part according to a second embodiment in oblique view from the force direction;

FIG. 9 is a sectional view of the load detection device according to the second embodiment taken along a stacking direction;

FIG. 10 is a sectional view of the load detection device according to a third embodiment taken along the stacking direction;

FIG. 11 is a plan view of the elastic deformation part according to a first modification when viewed from the force direction;

FIG. 12 is a plan view of the elastic deformation part according to a second modification when viewed from the force direction;

FIG. 13 is a plan view of the elastic deformation part according to a third modification when viewed from the force direction;

FIG. 14 is a perspective view of the elastic deformation part according to a fourth embodiment when viewed from the force direction;

FIG. 15 is a schematic of the arrangement of the elastic deformation part and the individual detection regions according to the fourth embodiment;

FIG. 16 is a sectional view taken along line XVI-XVI of FIG. 15 and viewed from the arrow direction;

FIG. 17 is a sectional view taken along line XVII-XVII of FIG. 15 and viewed from the arrow direction;

FIG. 18 is a schematic of the arrangement relation between the bottom surface of the protrusion and the individual detection regions according to a fourth modification;

FIG. 19 is a schematic of the arrangement relation between the bottom surface of the protrusion and the individual detection regions according to a fifth modification;

FIG. 20 is a sectional view of the force detector according to a sixth modification taken along the stacking direction;

FIG. 21 is a sectional view of the force detector according to a seventh modification taken along the stacking direction;

FIG. 22 is a sectional view of the force detector according to an eighth modification before force is applied taken along the stacking direction;

FIG. 23 is a sectional view of the force detector according to the eighth modification after force is applied taken along the stacking direction; and

FIG. 24 is a sectional view of the force detector according to a ninth modification before force is applied taken along the stacking direction.

### DETAILED DESCRIPTION

Exemplary aspects (embodiments) to embody a load detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by like reference numerals, and detailed explanation thereof may be appropriately omitted.

To describe an aspect regarding a certain structure on which another structure is disposed in the present specification and the claims, when “on” is simply used, it indicates both the following cases unless otherwise noted: a case where the other structure is disposed directly on and in contact with the certain structure, and a case where the other structure is disposed on the certain structure with yet another structure interposed therebetween.

### First Embodiment

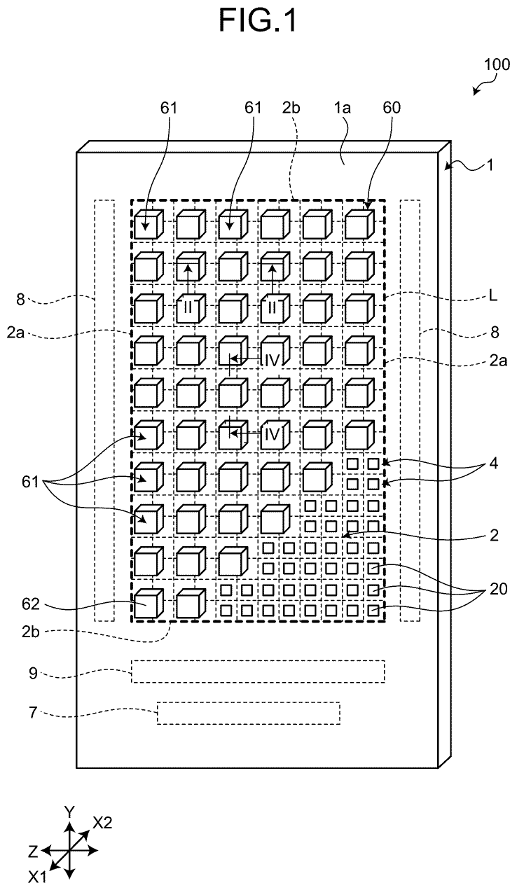

FIG. 1 is a perspective view schematically illustrating a load detection device according to a first embodiment. As illustrated in FIG. 1, a load detection device 100 includes a force detector 1 and an elastic deformation part 60 disposed on one surface (detection surface 1a) of the force detector 1. In the following description, the direction in which the force detector 1 and the elastic deformation part 60 are disposed is referred to as a stacking direction. In the stacking direction, the direction in which the elastic deformation part 60 is disposed when viewed from the force detector 1 is referred to as a first direction X1. The direction opposite to the first direction X1 is referred to as a force direction X2. The view from the force direction X2 is referred to plan view. The direction parallel to one surface (detection surface 1a) of the force detector 1 is referred to as a horizontal direction.

The load detection device 100 detects a load (force) in the force direction X2 and a load in the horizontal direction. The force detector 1 is a flat plate device having a small thickness in the stacking direction and extending in the horizontal direction. The force detector 1 has the detection surface 1a facing the first direction X1. The detection surface 1a of the force detector 1 is divided into a detection region 2 and a peripheral region 3. The detection region 2 is a region positioned at the center of the detection surface 1a and in which force can be detected. The peripheral region 3 surrounds the outer periphery of the detection region 2. The virtual line L in FIG. 1 is a boundary line (outer frame of the detection region 2) to facilitate understanding the boundary between the detection region 2 and the peripheral region 3.

The detection region 2 has a rectangular shape in plan view. Therefore, an outer frame L of the detection region 2 has a pair of long sides 2a and a pair of short sides 2b. The direction parallel to the long sides 2a is hereafter referred to as a second direction Y. The direction parallel to the short sides 2b is referred to as a third direction Z. The detection region 2 is divided into a plurality of sections in the second direction Y and the third direction Z. The divided regions are referred to as individual detection regions 4. The horizontal direction described above has the same meaning as a planar direction parallel to the second direction Y and the third direction Z.

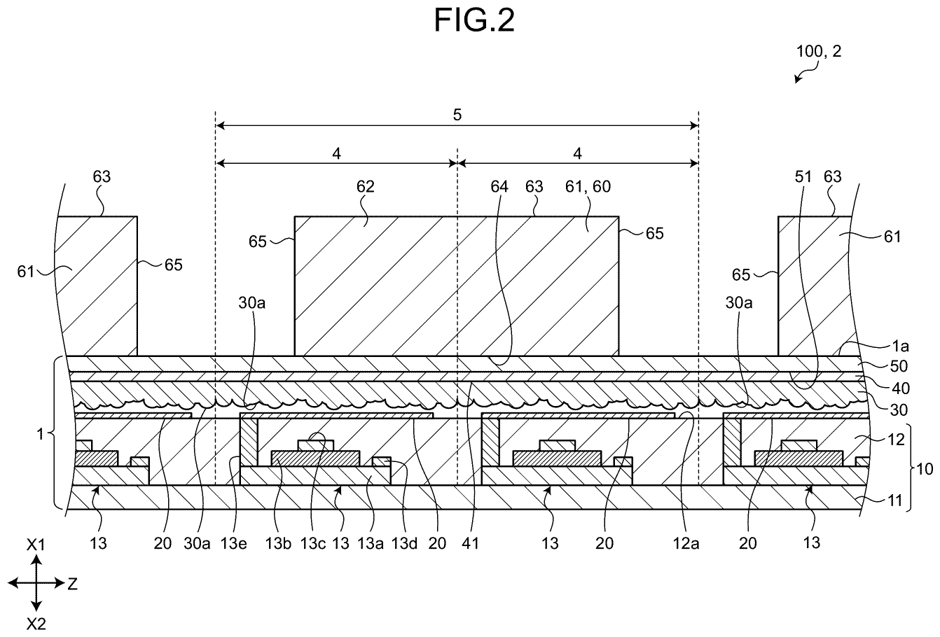

FIG. 2 is a sectional view taken along line II-II of FIG. 1 and viewed from the arrow direction. As illustrated in FIG. 2, the force detector 1 includes an array substrate 10, a sensor layer 30, a common electrode 40, and a protective layer 50 disposed in order in the first direction X1. The array substrate 10 includes a substrate 11 and an array layer 12 disposed in order in the first direction X1.

The substrate 11 is an insulating substrate serving as a base material of the array layer 12. The substrate 11 is made of material hard to deform if a load is applied to the force detector 1. The substrate 11 is a glass substrate or a resin substrate, for example.

The array layer 12 is stacked on and integrated with the substrate 11. The array layer 12 includes a plurality of insulating layers, which are not specifically illustrated, stacked in the stacking direction. A plurality of drive transistors (switch elements) 13 are provided inside the array layer 12. The drive transistors 13 are disposed in the detection region 2. The drive transistors 13 are provided to the respective individual detection regions 4. Therefore, the drive transistors 13 are arrayed in the second direction Y and the third direction Z corresponding to the respective individual detection regions 4.

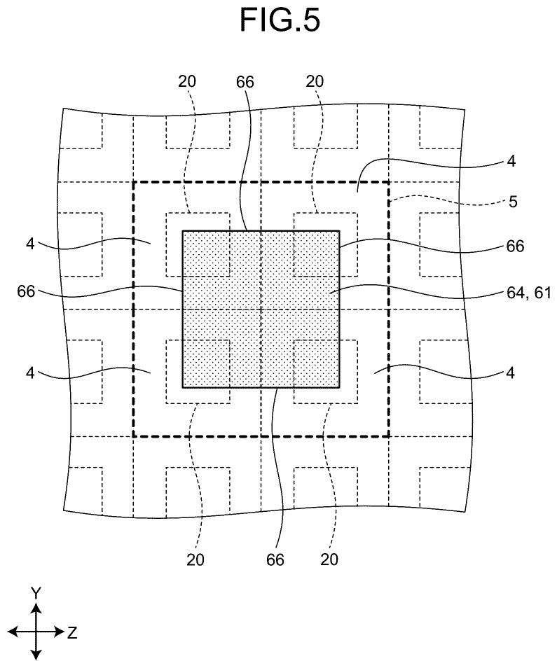

The array layer 12 has a first surface 12a facing the first direction X1. The first surface 12a is provided with a plurality of array electrodes 20. The array electrode 20 is made of metal material, such as indium tin oxide (ITO). The array electrode 20 has a rectangular shape in plan view (refer to FIG. 5). The array electrodes 20 are disposed in the detection region 2. The array electrodes 20 are provided to the respective individual detection regions 4. Therefore, the array electrodes 20 are arrayed in the second direction Y and the third direction Z corresponding to the respective individual detection regions 4 (refer to FIG. 1). The array electrode 20 is positioned at the center of the individual detection region 4 in plan view (refer to FIG. 5).

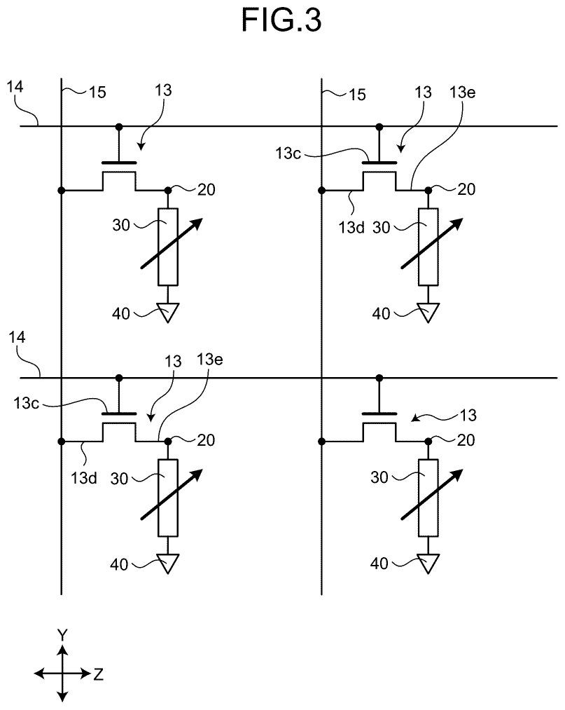

The array layer 12 includes various components for driving the drive transistors 13. Specifically, the array layer 12 includes a coupler 7 (refer to FIG. 1), a gate line drive circuit 8 (refer to FIG. 1), a signal line selection circuit 9 (refer to FIG. 1), gate lines 14 (refer to FIG. 3), and signal lines 15 (refer to FIG. 3).

As illustrated in FIG. 1, the coupler 7, the gate line drive circuit 8, and the signal line selection circuit 9 are disposed in the peripheral region 3. The coupler 7 couples the force detector 1 to a drive integrated circuit (IC) disposed outside the force detector 1. The drive IC according to the present disclosure may be mounted as a chip on film (COF) on a flexible printed circuit board or a rigid circuit board coupled to the coupler 7. Alternatively, the drive IC may be mounted as a chip on glass (COG) in the peripheral region 3.

The gate line drive circuit 8 is a circuit that drives the gate lines 14 (refer to FIG. 3) based on various control signals from the drive IC. The gate line drive circuit 8 sequentially or simultaneously selects the gate lines 14 and supplies gate drive signals to the selected gate lines 14. The signal line selection circuit 9 is a switch circuit that sequentially or simultaneously selects the signal lines 15 (refer to FIG. 3). The signal line selection circuit 9 is a multiplexer, for example. The signal line selection circuit 9 couples the selected signal lines 15 to the drive IC based on selection signal supplied from the drive IC.

FIG. 3 is a circuit diagram of a circuit configuration of a force sensor according to the first embodiment. As illustrated in FIG. 3, each gate line 14 extends in the third direction Z in the detection region 2. A plurality of gate lines 14 are arrayed in the second direction Y in the detection region 2. Each signal line 15 extends in the second direction Y in the detection region 2. A plurality of signal lines 15 are arrayed in the third direction Z in the detection region 2. The array layer 12 also includes common wiring, which is not specifically illustrated, extending along the peripheral region 3. The common wiring is wiring for supplying a current to the common electrode 40. The common wiring is coupled to the drive IC via the coupler 7 and is supplied with a certain amount of electric current from the drive IC.

As illustrated in FIG. 2, the drive transistor 13 includes a semiconductor layer 13a, a gate insulating film 13b, a gate electrode 13c, a drain electrode 13d, and a source electrode 13e. The source electrode 13e is coupled to the array electrode 20. The gate electrode 13c is coupled to the gate line 14 (refer to FIG. 3). The drain electrode 13d is coupled to the signal line 15 (refer to FIG. 3). When the gate line 14 is scanned, the drive transistor 13 is closed. As a result, an electrical signal (current value) input to the array electrode 20 is output to the signal line 15 via the drive transistor 13. The electrical signal (current value) is transmitted from the signal line 15 to the drive IC.

The protective layer 50 is an insulating layer extending in the horizontal direction. The peripheral region 3 on the first surface 12a of the array substrate 10 is provided with a frame-shaped spacer, which is not illustrated. The protective layer 50 is supported by the spacer, which is not illustrated. As a result, the protective layer 50 is spaced apart from the array substrate 10 in the first direction X1. The protective layer 50 has the detection surface 1a facing the first direction X1 and a facing surface 51 facing the force direction X2 and the array electrode 20.

The common electrode 40 is made of metal material, such as indium tin oxide (ITO). The common electrode 40 is a solid film deposited on the facing surface 51 of the protective layer 50 and is provided in the entire detection region 2. The common electrode 40 is coupled to the common wiring (not illustrated) by wiring, which is not illustrated. Therefore, the common electrode 40 is supplied with a certain amount of current from the drive IC.

The sensor layer 30 is provided on a surface 41 facing the force direction X2 of the common electrode 40. The sensor layer 30 is provided in the entire detection region 2. The sensor layer 30 is made of conductive resin. The sensor layer 30 is provided with a plurality of protrusions 30a on the surface facing the force direction X2. Each protrusion 30a is spaced apart from the array electrode 20 and the first surface 12a of the array layer 12. Therefore, a space is formed between the sensor layer 30, and the array electrode 20 and the first surface 12a.

The elastic deformation part 60 is made of elastically deformable material. Therefore, the elastic deformation part 60 deforms when a load is applied thereto and returns to its original shape when the load is removed. While examples of the typical material of the elastic deformation part 60 include, but are not limited to, rubber, resin, etc., the present disclosure is not limited to these materials.

As illustrated in FIG. 1, the elastic deformation part 60 according to the first embodiment includes a plurality of protrusions 61. The protrusion 61 has a quadrangular prism shape. The protrusions 61 are arrayed in the second direction Y and the third direction Z. FIG. 1 does not illustrate some of the protrusions 61 to make the inside of the detection region 2 easy to see.

The elastic deformation part 60 according to the present embodiment is composed only of a plurality of protrusions 61. In other words, the protrusions 61 are independent of each other. As illustrated in FIG. 2, the end of the protrusion 61 in the first direction X1 is a top end 62. A load is applied to the top end 62. The protrusion 61 has a top end surface 63 facing the first direction X1, a bottom surface 64 facing the force direction X2, and four side surfaces 65. The top end surface 63 and the bottom surface 64 each have a square (quadrilateral) shape.

The bottom surface 64 is fixed to the detection surface 1a of the force detector 1. While examples of the fixing method include, but are not limited to, adhesion, welding, etc., the present disclosure is not limited to these methods. Two of the four side surfaces 65 face the second direction Y and the other two face the third direction Z. Therefore, two protrusions 61 disposed side by side in the second direction Y or the third direction Z are provided with the side surfaces 65 facing each other.

The sectional shape of the protrusion 61 taken along a virtual plane extending in the stacking direction and the third direction Z is a quadrilateral. The protrusions 61 are each spaced apart from the other protrusions 61 disposed in the third direction Z.

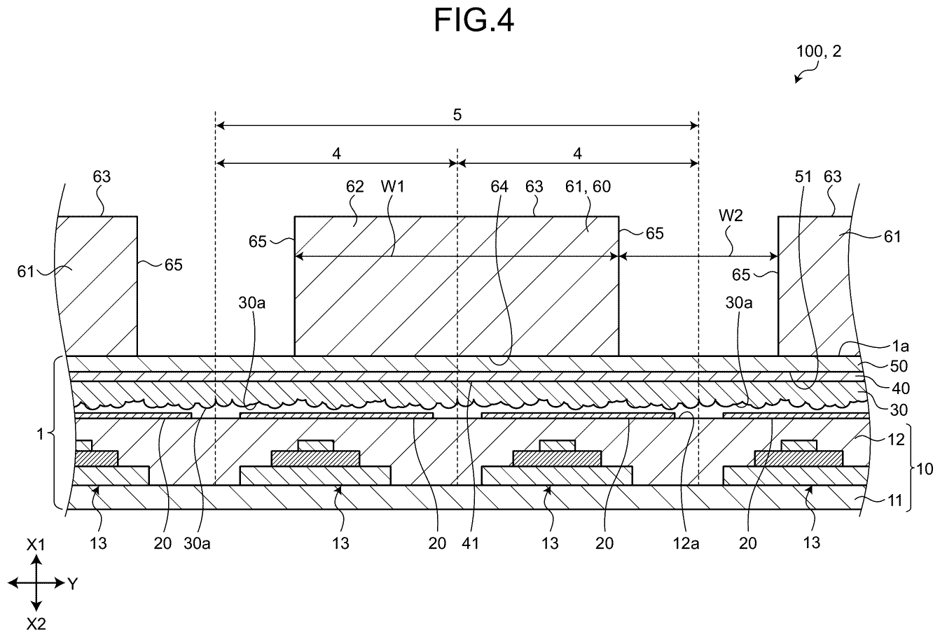

FIG. 4 is a sectional view taken along line IV-IV of FIG. 1 and viewed from the arrow direction. As illustrated in FIG. 4, the sectional shape of the protrusion 61 taken along a virtual plane extending in the stacking direction and the second direction Y is a quadrilateral. As illustrated in FIG. 4, the protrusions 61 are each spaced apart from the other protrusions 61 disposed in the second direction Y.

FIG. 5 is a schematic of the correspondence between the protrusion and the individual detection regions according to the first embodiment. As illustrated in FIG. 5, the protrusion 61 is disposed over a plurality of individual detection regions 4 in plan view. Therefore, when a load is applied to one protrusion 61, it acts on (is transmitted to) the four individual detection regions 4. In the following description, the four individual detection regions are collectively referred to as a load detection region 5. The bottom surface 64 has four sides 66. Each side 66 overlaps the array electrodes 20 in plan view.

The following describes the operating method of the load detection device 100 according to the first embodiment. The operating method is described in order of a case where force (load in the force direction X2) is applied to the protrusion 61 and a case where a load in the horizontal direction is applied to the protrusion 61.

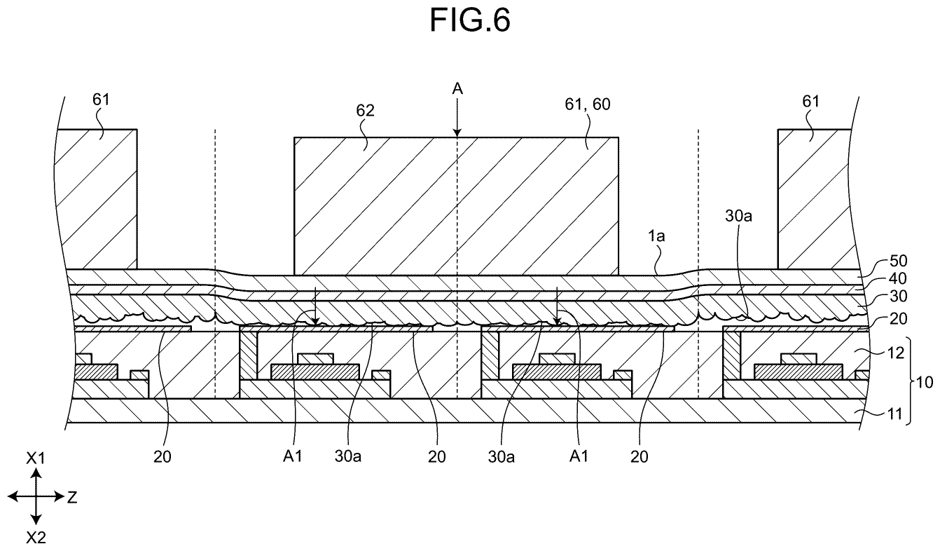

FIG. 6 is a sectional view of a state where force (load in the force direction X2) is applied to the protrusion according to the first embodiment. As illustrated in FIG. 6, when force A is applied to the top end surface 63 of the protrusion 61, a load is transmitted from the protrusion 61 to the common electrode 40 and the sensor layer 30. As a result, the common electrode 40 and the sensor layer 30 move in the force direction X2, and the protrusions 30a of the sensor layer 30 come into contact with the array electrode 20.

As a result, the array electrode 20 is electrically coupled to the common electrode 40, and a current flows from the common electrode 40 to the array electrode 20 (refer to arrow A1 in FIG. 6). The current flowing to the array electrode 20 is transmitted to the drive IC via the signal line 15. The drive IC receives a detection signal (current), thereby detecting that the load is applied to the individual detection region 4.

When the force A applied to the protrusion 61 is large, the number of protrusions 30a in contact with the array electrode 20 increases, and the contact area with the array electrode 20 increases. In addition, the protrusions 30a are pressed against and planarized on the array electrode 20, thereby increasing the contact area with the array electrode 20. For this reason, the amount of current input to the array electrode 20 increases in proportion to an increase in the force A (increase in the contact area). Therefore, the drive IC detects the magnitude of the load acting on the individual detection region 4 from the magnitude of the received current value.

If the load acting on the protrusion 61 is force (load in the force direction X2), the force acting on the protrusion 61 is evenly distributed to the four individual detection regions 4. In other words, the loads (current values) detected in the respective four individual detection regions 4 included in the load detection region 5 are equal. As described above, when the magnitudes of the current values received from the respective array electrodes 20 are equal, the drive IC determines that the direction of the load acting on the protrusion 61 is the force direction X2.

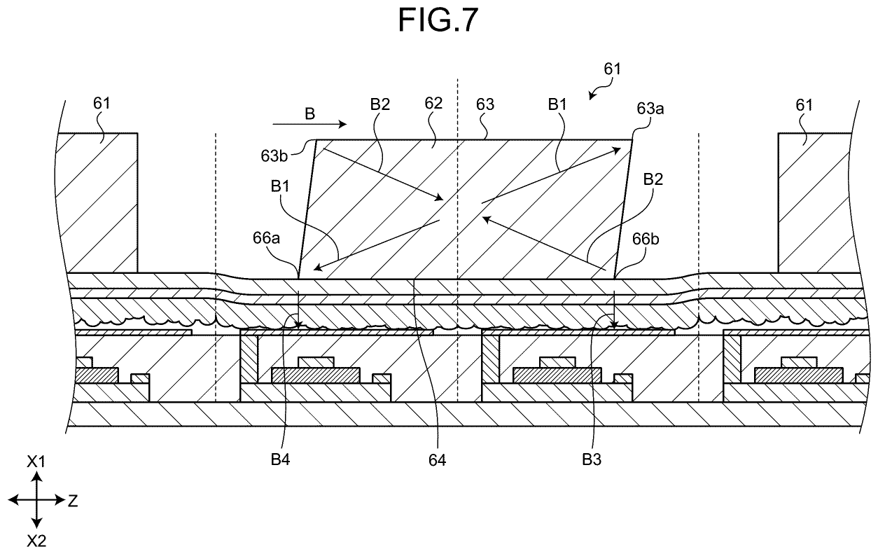

FIG. 7 is a sectional view of a state where a load in the horizontal direction is applied to the protrusion according to the first embodiment. The following describes a case where a load in the horizontal direction (refer to arrow B in FIG. 7) is applied to the protrusion 61. The load in the horizontal direction described herein is a load in the third direction Z (hereinafter referred to as a horizontal load B).

The horizontal load B includes a load component in the force direction X2. Therefore, a load in the force direction X2 acts on the detection surface 1a from the bottom surface 64 of the protrusion 61. As a result, the sensor layer 30 belonging to the four individual detection regions 4 comes into contact with the array electrodes 20, and a current flows from the common electrode 40 to the array electrodes 20. For this reason, the loads in the force direction X2 are detected from the respective individual detection regions 4 when the horizontal load B is applied to the protrusion 61.

As illustrated in FIG. 6, when the horizontal load B is applied to the top end 62 of the first protrusion 61, the top end 62 of the first protrusion 61 moves in the direction of the load (third direction Z). By contrast, the bottom surface 64 of the first protrusion 61 is fixed, and the first protrusion 61 does not move. Therefore, the first protrusion 61 is sheared, and the sectional shape of the first protrusion 61 becomes a parallelogram.

When the sectional shape of the first protrusion 61 becomes a parallelogram, shear stress is generated in the first protrusion 61. As a result, extensional stress (arrow B1) extending on a diagonal line acts between the side (side 63a in FIG. 6) positioned in the direction of the horizontal load B out of the four sides of the top end surface 63 and the side (refer to a side 66a in FIG. 6) positioned in the opposite direction of the horizontal load B out of the four sides 66 of the bottom surface 64. This reduces the load in the force direction X2 acting on the detection surface 1a from the bottom surface 64 at a portion of the bottom surface 64 near the side (refer to the side 66a in FIG. 6) positioned in the opposite direction of the horizontal load B.

Compressive stress (arrow B2) compressing on a diagonal line acts between the side (side 63b in FIG. 6) positioned in the opposite direction of the horizontal load B out of the four sides of the top end surface 63 and the side (side 66b in FIG. 6) positioned in the direction of the horizontal load B out of the four sides 66 of the bottom surface 64. This increases the load in the force direction X2 acting on the detection surface 1a from the bottom surface 64 at a portion of the bottom surface 64 near the side (refer to the side 66b in FIG. 6) positioned in the direction of the horizontal load B.

For this reason, the load in the force direction X2 acting on the detection surface 1a from the bottom surface 64 varies in the bottom surface 64. The load becomes larger as the portion is positioned in the direction of the horizontal load B and smaller as the portion is positioned in the opposite direction of the horizontal load B. As described above, a bias occurs in the load in the force direction X2 acting on the detection surface 1a from the bottom surface 64 of the first protrusion 61.

Therefore, when the horizontal load B is applied, the contact area between the sensor layer 30 and the array electrode 20 is larger in the individual detection region 4 to which the side 66b belongs than in the individual detection region 4 to which the side 66a belongs. As a result, the amount of current input to the array electrode 20 in the individual detection region 4 to which the side 66b belongs (refer to arrow B3 in FIG. 7) is larger than the amount of current input to the array electrode 20 in the individual detection region 4 to which the side 66a belongs (refer to arrow B4 in FIG. 7).

If the drive IC determines that the amounts of current detected from the respective four individual detection regions 4 included in the load detection region 5 are not equal, it determines that the direction of the load applied to the protrusion 61 is the horizontal direction. The drive IC identifies the direction in which the individual detection region 4 with the larger detected amount of current is positioned with respect to the individual detection region 4 with the smaller detected amount of current out of the four individual detection regions 4 as the direction of the load in the horizontal direction.

As the horizontal load B increases, the bias in the load in the force direction X2 acting on the detection surface 1a from the bottom surface 64 increases. Therefore, the drive IC calculates the difference (bias) in the amounts of current detected from the respective individual detection regions 4 to calculate the magnitude of the horizontal load B.

The following describes the advantageous effects of the first embodiment. The protrusion 61 according to the first embodiment is spaced apart from the protrusions 61 adjacent thereto in the second direction Y and the third direction Z. With this configuration, if the top end 62 of the protrusion 61 moves in the second direction Y or the third direction Z, the protrusion 61 is unlikely to come into contact with the adjacent protrusions 61 as illustrated in FIG. 7. Therefore, the horizontal load can be detected if the sectional shape of the protrusion 61 is a rectangle.

As described above, if the load applied to the protrusion 61 is a load in the horizontal direction, the force load acting on the detection surface 1a from the bottom surface 64 of the protrusion 61 more significantly varies at portions closer to the four sides 66 of the bottom surface 64. In other words, the bias in the load due to the shear stress more significantly affects the portions closer to the four sides 66 of the bottom 64. The present embodiment has high sensitivity to detect the load in the horizontal direction because the four sides 66 of the bottom surface 64 overlap the array electrodes 20 (refer to FIG. 5).

When the length of the protrusion 61 in the horizontal direction is W1, the distance W2 between the protrusions 61 is preferably W1×0.1 or larger and more preferably W1×0.5 or larger.

While the load detection device 100 according to the first embodiment has been described above, the load detection device according to the present disclosure may be configured such that the top end of the protrusion 61 moves by a predetermined amount in the horizontal direction and come into contact with another protrusion 61. When the protrusion 61 comes into contact with another protrusion 61, the movement of the top end 62 of the protrusion 61 is slightly restricted. The load in the horizontal direction, however, can be detected because the shear stress is generated in the protrusion 61. Next, other embodiments of the load detection device are described. The following mainly describes the points different from the first embodiment.

### Second Embodiment

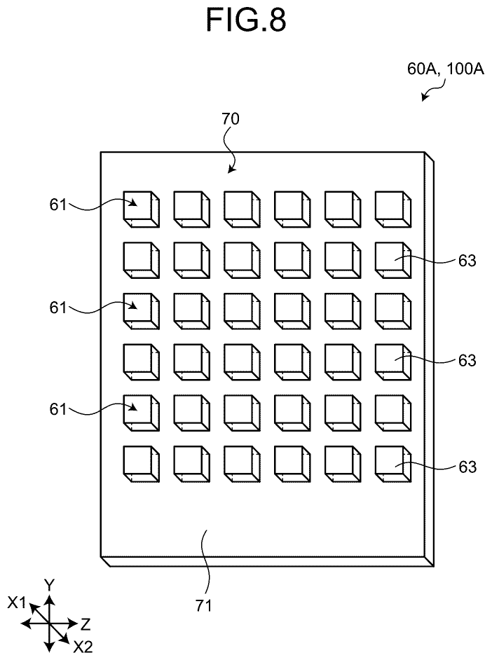

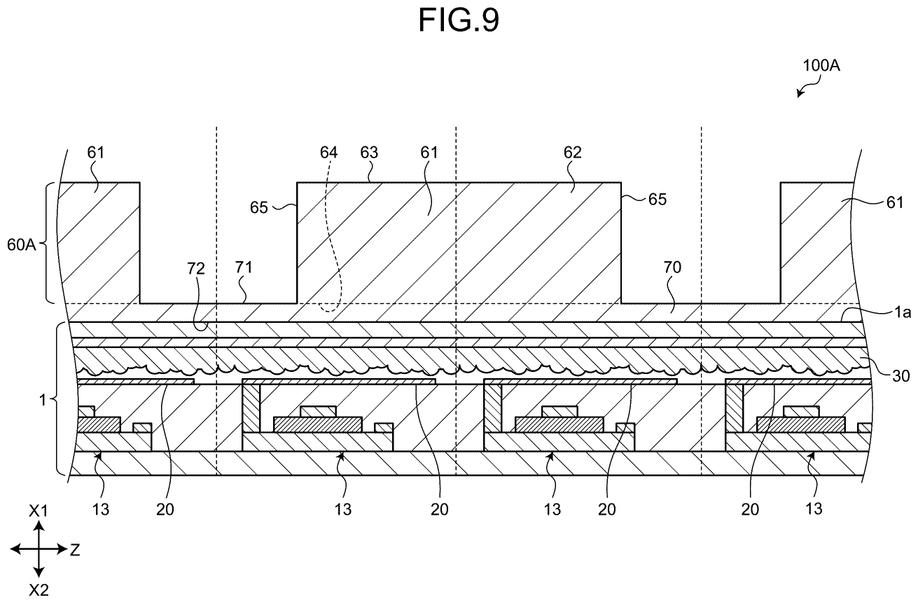

FIG. 8 is a schematic of the elastic deformation part according to a second embodiment in oblique view from the force direction. FIG. 9 is a sectional view of the load detection device according to the second embodiment taken along the stacking direction. A load detection device 100A according to the second embodiment is different from the load detection device 100 according to the first embodiment in that it includes an elastic deformation part 60A instead of the elastic deformation part 60.

As illustrated in FIG. 8, the elastic deformation part 60A includes a plurality of protrusions 61 and a plate-shaped elastic deformation body 70. The elastic deformation body 70 extends in directions (horizontal direction) parallel to the second direction Y and the third direction Z. The elastic deformation body 70 has a first surface 71 facing the first direction X1 and a second surface 72 (refer to FIG. 9) facing the force direction X2.

As illustrated in FIG. 9, the protrusions 61 and the elastic deformation body 70 are integrally formed from the same material. In other words, the first surface 71 of the elastic deformation body 70 is continuous with the bottom surfaces 64 of the protrusions 61. The second surface 72 of the elastic deformation body 70 is in contact with the detection surface 1a of the force detector 1. The second surface 72 is fixed to the detection surface 1a with a double-sided tape or the like. The area in which the second surface 72 and the detection surface 1a are fixed is not particularly limited. For example, the entire surfaces may be fixed, or the surfaces may be fixed in the peripheral region 3.

The second embodiment can save the work of disposing the protrusions 61 one by one on the detection surface 1a. While the protrusions 61 and the elastic deformation body 70 of the elastic deformation part 60A according to the second embodiment are made of the same material, the protrusions 61 and the elastic deformation body 70 according to the present disclosure may be made of different materials. In other words, the protrusions 61 and the elastic deformation body 70 may be separately manufactured, and the protrusions 61 may be fixed to the elastic deformation body 70.

### Third Embodiment

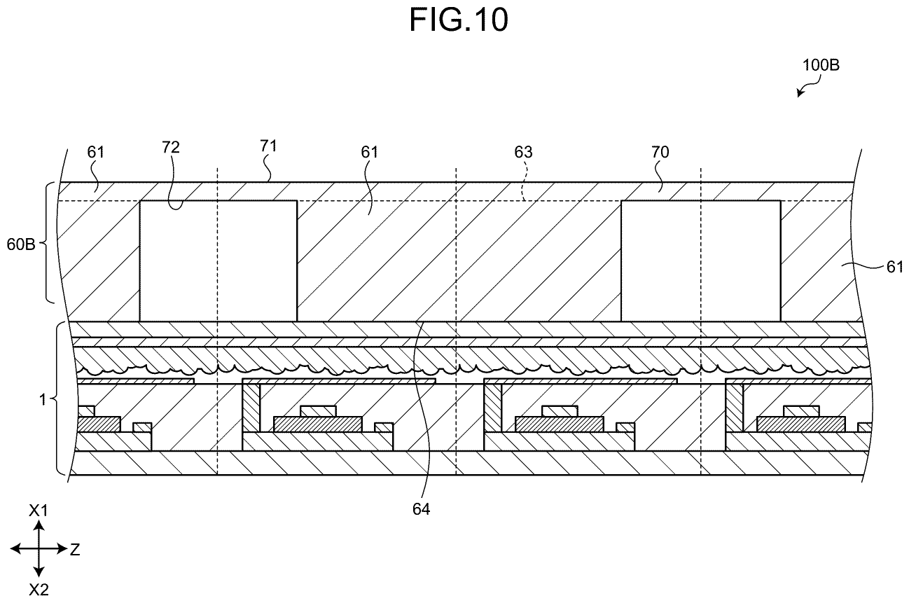

FIG. 10 is a sectional view of the load detection device according to a third embodiment taken along the stacking direction. As illustrated in FIG. 10, a load detection device 100B according to the third embodiment is different from the load detection device 100 according to the first embodiment in that it includes an elastic deformation part 60B instead of the elastic deformation part 60. The elastic deformation part 60B is the same as the elastic deformation part 60A according to the second embodiment in that it includes the elastic deformation body 70. The elastic deformation body 70 according to the third embodiment, however, is different from that according to the second embodiment in that it is continuous not with the bottom surfaces 64 of the protrusions 61 but with the top end surfaces 63. Similarly to the second embodiment, the elastic deformation part 60B with this configuration can also save the work of disposing the protrusions 61 one by one on the detection surface 1a.

In the configuration according to the third embodiment, the elastic deformation body 70 is continuous with the top end surfaces 63 of the protrusions 61. Therefore, the top ends 62 of the protrusions 61 are harder to move in the horizontal direction than in the second embodiment. Modifications of the third embodiment improved on this point are described below.

### First Modification

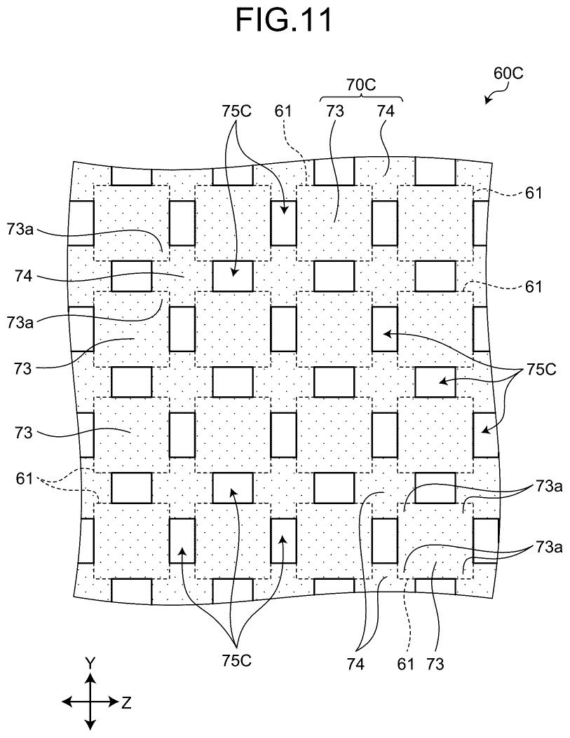

FIG. 11 is a plan view of the elastic deformation part according to a first modification when viewed from the force direction. As illustrated in FIG. 11, an elastic deformation body 70C of an elastic deformation part 60C according to the first modification has a plurality of through holes 75C. In the example illustrated in FIG. 11, the through hole 75C has a rectangular shape. All the through holes 75C overlap the gaps between the protrusions 61 in plan view. Therefore, the elastic deformation body 70C according to the first modification is composed of a plurality of overlapping portions 73 and a plurality of coupling portions 74. The overlapping portions 73 overlap the respective protrusions 61 in the first planar direction X1. The coupling portions 74 each couple a plurality of overlapping portions 73. The overlapping portion 73 has a quadrilateral shape in plan view, which is the same shape as that of the protrusion 61. The coupling portion 74 has a cross shape in plan view and couples corners 74 of the overlapping portions 73. The through hole 75C according to the present disclosure may have a shape, such as an ellipse and a quadrilateral, other than a rectangle.

According to the first modification described above, the through holes 75C are formed in the elastic deformation body 70C, and the elastic deformation body 70C has low rigidity. In other words, the first modification is less likely to prevent the top end 62 of the protrusion 61 from moving in the horizontal direction. Therefore, the top end surface 63 of the protrusion 61 is more likely to move in the horizontal direction than in the third embodiment.

### Second Modification

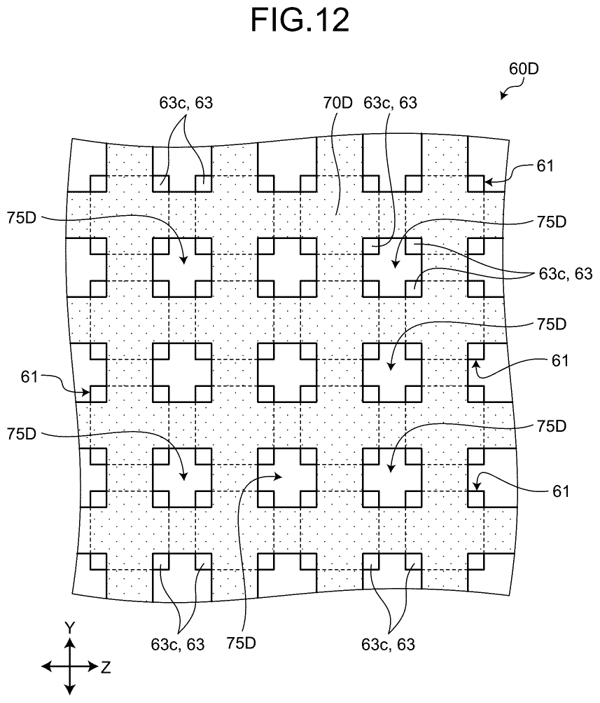

FIG. 12 is a plan view of the elastic deformation part according to a second modification when viewed from the force direction. As illustrated in FIG. 12, an elastic deformation body 70D of an elastic deformation part 60D according to the second modification has a plurality of through holes 75D. In the example illustrated in FIG. 12, the through hole 75D has a quadrilateral shape. The through hole 75D is formed at the center of four protruding portions 61 in plan view. The corners of the through hole 75D overlap corners 63c of the top end surfaces 63 of the four protruding portions 61, and the corners 63c of the protruding portions 61 are exposed through the through hole 75D. Therefore, the through hole 75D according to the second modification partially overlaps the gap formed between the protruding portions 61. According to the second modification, the through holes 75D are formed in the elastic deformation body 70D, and the elastic deformation body 70D has low rigidity. Therefore, the top end surface 63 of the protrusion 61 is more likely to move in the horizontal direction than in the third embodiment. The through hole 75D according to the present disclosure may have a shape, such as a circle, other than a quadrilateral.

### Third Modification

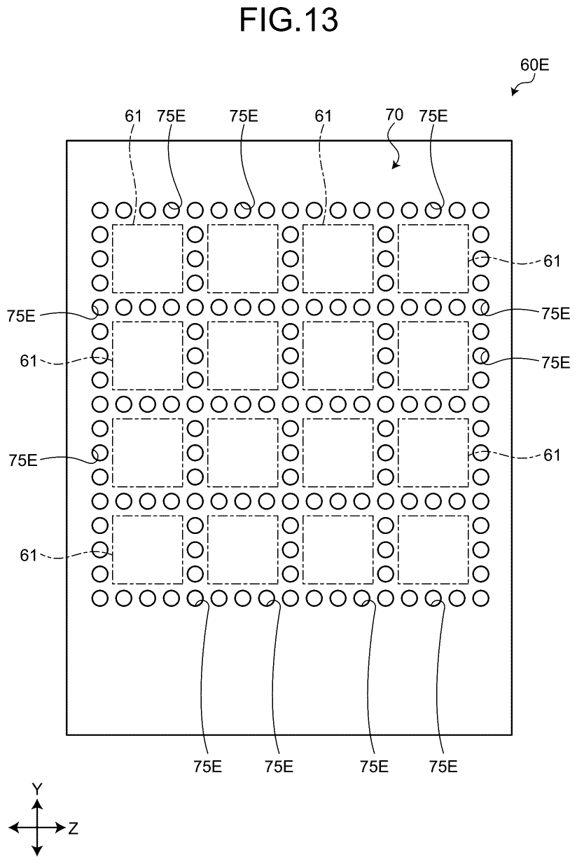

FIG. 13 is a plan view of the elastic deformation part according to a third modification when viewed from the force direction. An elastic deformation part 60E according to the third modification includes an elastic deformation body 70E described in the third embodiment. The elastic deformation body 70 has a plurality of circular through holes 75E. The through holes 75E are formed between the protrusions 61 in plan view. Therefore, the elastic deformation body 70E has low rigidity, and the top end 62 of the protrusion 61 is more likely to move in the horizontal direction than in the third embodiment.

While the embodiments and modifications above have described the elastic deformation part in which the protrusions are not continuous, the protrusions according to the present disclosure may be continuous. The following describes the elastic deformation part according to a fourth embodiment in detail.

### Fourth Embodiment

FIG. 14 is a perspective view of the elastic deformation part according to the fourth embodiment when viewed from the force direction. A load detection device 100F according to the fourth embodiment includes an elastic deformation part 80. The elastic deformation part 80 has a grid shape in plan view. Therefore, the elastic deformation part 80 includes a plurality of first walls 81 and a plurality of second walls 82. The first walls 81 extend in the second direction Y and are arrayed in the third direction Z. The second walls 82 extend in the third direction Z and are arrayed in the second direction Y. The first walls 81 and the second walls 82 intersect each other at 90°.

The portion of the elastic deformation part 80 where the first wall 81 and the second wall 82 intersect is hereinafter referred to as an intersection 83. The portion of the first wall 81 positioned between the intersections 83 is referred to as a first protruding portion 84. The portion of the second wall 82 positioned between the intersections 83 is referred to as a second protruding portion 85.

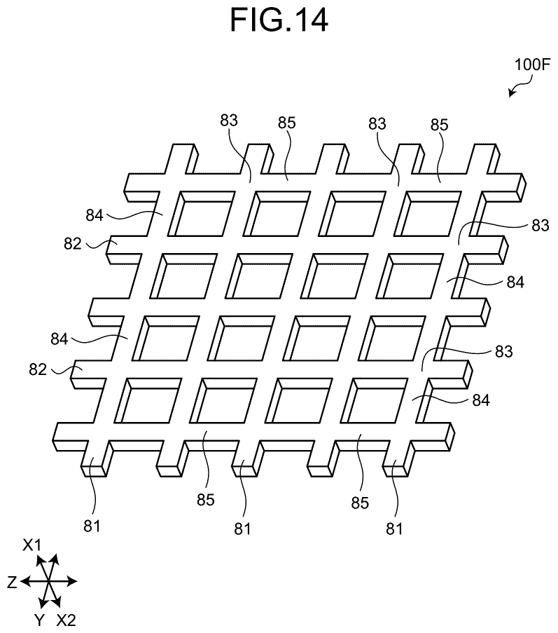

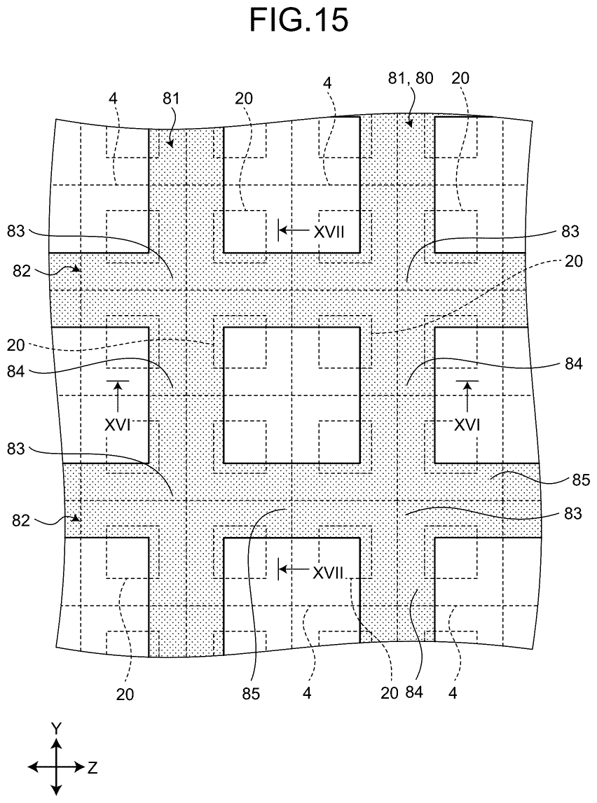

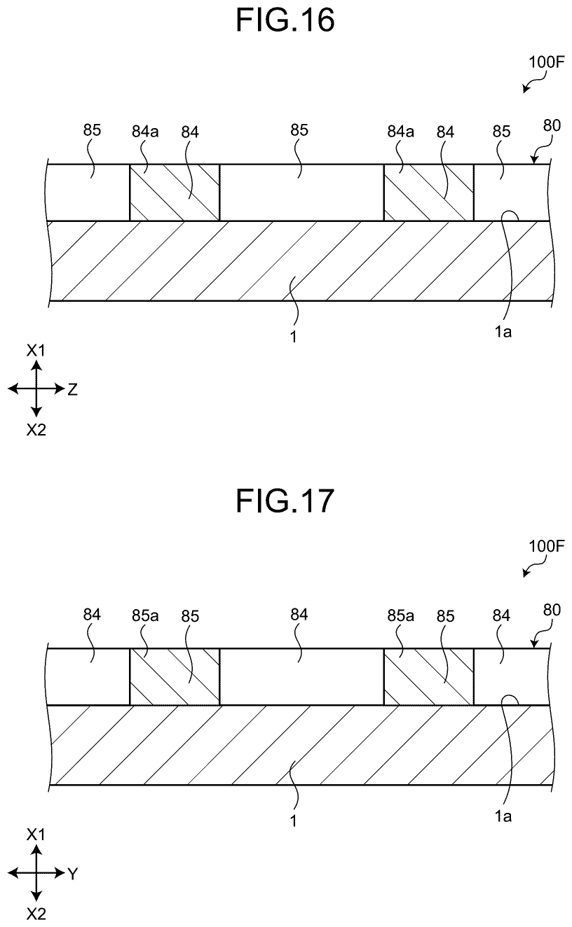

FIG. 15 is a schematic of the arrangement of the elastic deformation part and the individual detection regions according to the fourth embodiment. FIG. 16 is a sectional view taken along line XVI-XVI of FIG. 15 and viewed from the arrow direction. As illustrated in FIG. 15, the first protruding portion 84 is disposed over two array electrodes 20 arrayed in the third direction Z. By contrast, the second protruding portion 85 is disposed over two array electrodes 20 arrayed in the second direction Y.

As illustrated in FIG. 16, the first protruding portion 84 has a rectangular sectional shape taken along a virtual plane extending in the first direction X1 and the third direction Z. The first protruding portion 84 is spaced apart from the other first protruding portions 84 disposed in the third direction Z. Therefore, when a horizontal load in the third direction Z acts on the first protruding portion 84, a top end 84a of the first protruding portion 84 moves in the direction of the load, and shear stress acts on the first protruding portion 84. As a result, the first protruding portion 84 can detect the horizontal load in the third direction Z.

By contrast, as illustrated in FIG. 15, the first protruding portion 84 is adjacent to the intersection 83 disposed in the second direction Y. Therefore, if a load in the second direction Y acts on the first protruding portion 84, the top end 84a of the first protruding portion 84 does not move in the direction of the load. In other words, the first protruding portion 84 fails to detect the horizontal load in the second direction Y.

FIG. 17 is a sectional view taken along line XVII-XVII of FIG. 15 and viewed from the arrow direction. As illustrated in FIG. 17, the second protruding portion 85 has a rectangular sectional shape taken along a virtual plane extending in the first direction X1 and the second direction Y. The second protruding portion 85 is spaced apart from the other second protruding portions 85 disposed in the second direction Y. Therefore, when a horizontal load in the second direction Y is applied to the second protruding portion 85, a top end 85a of the second protruding portion 85 moves in the second direction Y, and shear stress acts on the second protruding portion 85. As a result, the second protruding portion 85 can detect the horizontal load in the second direction Y.

By contrast, as illustrated in FIG. 15, the second protruding portion 85 is adjacent to the intersection 83 disposed in the third direction Z with respect to the second protruding portion 85. Therefore, if a load in the third direction Z acts on the second protruding portion 85, the top end 85a of the second protruding portion 85 does not move in the direction of the load. Therefore, the second protruding portion 85 fails to detect the load in the third direction Z.

As described above, the fourth embodiment can detect the load in the horizontal direction if the sectional shape of the protruding portions (the first protruding portion 84 and the second protruding portion 85) is rectangular. In addition, the elastic deformation part 80 is easy to dispose on the detection surface 1a because it is integrally formed.

While the embodiments and modifications have been described above, the present disclosure is not limited to those described above. For example, while the sectional shape of the protrusion 61 taken along the horizontal direction is a quadrilateral, it may be a circle or a polygon and is not particularly limited.

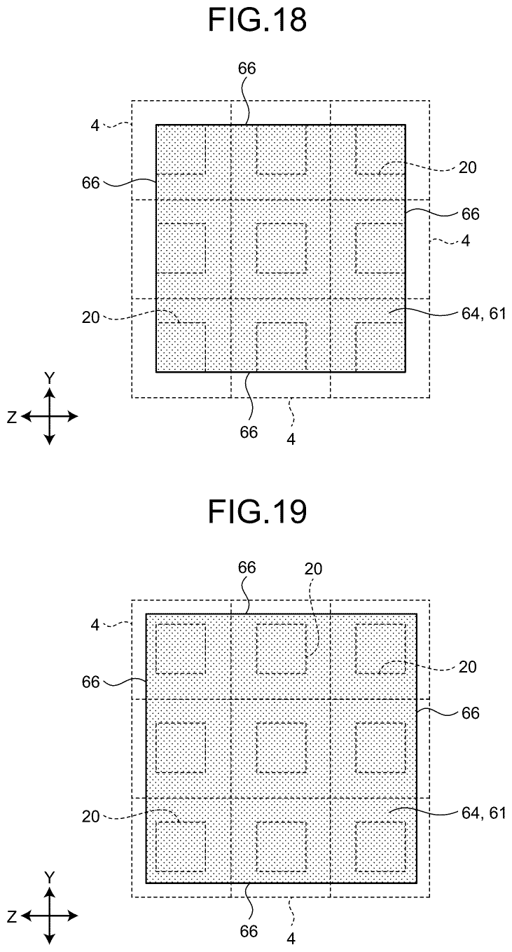

While one protrusion 61 according to the embodiments overlaps the four individual detection regions 4, the present disclosure is not limited thereto. FIG. 18 is a schematic of the arrangement relation between the bottom surface of the protrusion and the individual detection regions according to a fourth modification. As illustrated in FIG. 18, for example, the protrusion 61 may be disposed overlapping the individual detection regions 4 in three rows in the second direction Y and in three columns in the third direction Z, that is, a total of nine individual detection regions 4. The arrangement relation according to the present disclosure may be appropriately changed.

As illustrated in FIG. 18, the four sides 66 of the bottom surface 64 of the protrusion and the protruding portion may be disposed overlapping the sides of the array electrodes 20. FIG. 19 is a schematic of the arrangement relation between the bottom surface of the protrusion and the individual detection regions according to a fifth modification. As illustrated in FIG. 19, the four sides 66 of the bottom surface 64 according to the present disclosure may be disposed not overlapping the array electrodes 20.

While a gap is formed between the protrusions (protruding portions) according to the embodiments and modifications described above, the gap according to the present disclosure may be filled with a certain material. The material filling the gap, however, preferably has low rigidity to facilitate deformation of the protrusions (protruding portions).

While the array electrode 20 and the common electrode 40 according to the embodiments face each other with the sensor layer 30 interposed therebetween, the present disclosure is not limited thereto. The following describes sixth and seventh modifications that employ other arrangement examples.

### Sixth Modification

FIG. 20 is a sectional view of the force detector according to the sixth modification taken along the stacking direction. The array electrode 20 and the common electrode 40 of a force detector 1G according to the sixth modification are disposed on the first surface 12a of the array substrate 10. Therefore, the array electrode 20 and the common electrode 40 are disposed in the horizontal direction. When force is applied, the sensor layer 30 comes into contact with the array electrode 20 and the common electrode 40, and a current flows from the common electrode 40 to the array electrode 20.

### Seventh Modification

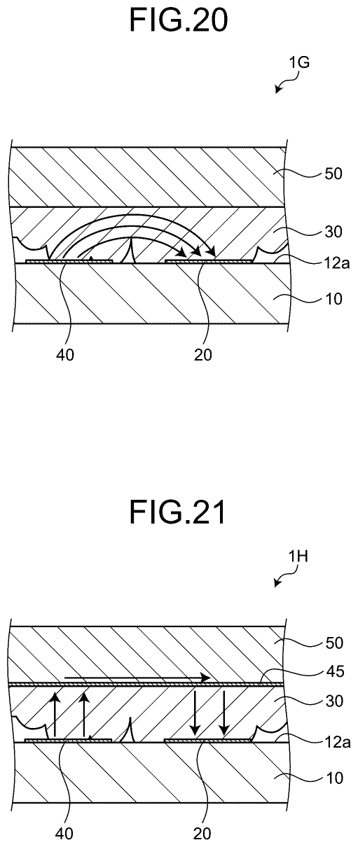

FIG. 21 is a sectional view of the force detector according to the seventh modification taken along the stacking direction. A force detector 1H according to the seventh modification includes the array electrode 20, the common electrode 40, and an intermediate electrode 45. Similarly to the sixth modification, the array electrode 20 and the common electrode 40 are disposed on the first surface 12a of the array substrate 10. The intermediate electrode 45 is disposed between the sensor layer 30 and the protective layer 50. When force is applied, the sensor layer 30 comes into contact with the array electrode 20 and the common electrode 40. With this configuration, a current flows from the common electrode 40 to the intermediate electrode 45 and then flows from the intermediate electrode 45 to the array electrode 20.

While the sensor layer 30 according to the embodiments is made of conductive resin with the protrusions 30a on the surface in the force direction X2, the present disclosure is not limited thereto. The following describes eighth and ninth modifications that employ other sensor layers.

### Eighth Modification

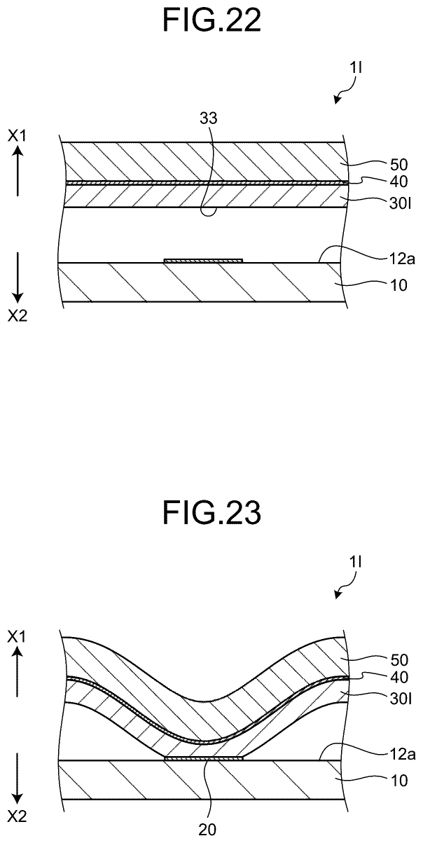

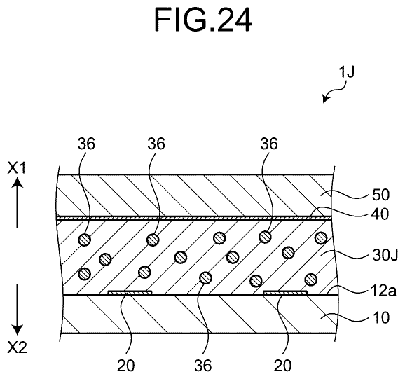

FIG. 22 is a sectional view of the force detector according to the eighth modification before force is applied taken along the stacking direction. FIG. 23 is a sectional view of the force detector according to the eighth modification after force is applied taken along the stacking direction. As illustrated in FIG. 22, a sensor layer 301 of a force detector 1I according to the eighth modification is made of conductive resin. A surface 33 of the sensor layer 301 in the force direction X2 is flat in the horizontal direction and is not in contact with the array electrode 20.

As illustrated in FIG. 23, when force is applied, the sensor layer 301 moves in the force direction X2 and comes into contact with the array electrode 20. As a result, a current flows from the common electrode 40 to the array electrode 20. As the force increases, the contact area between the sensor layer 30I and the array electrode 20 increases. Therefore, the amount of current flowing from the common electrode 40 to the array electrode 20 increases.

### Ninth Modification

FIG. 24 is a sectional view of the force detector according to the ninth modification before force is applied taken along the stacking direction. As illustrated in FIG. 24, a sensor layer 30J of a force detector 1J according to the ninth modification includes conductive particles 36 inside insulating resin. The surface of the sensor layer 30J in the force direction X2 is in contact with the array electrode 20 and the first surface 12a of the array substrate 10.

When no force acts on the sensor layer 30J, that is, when the sensor layer 30J is not deformed, the particles 36 are separated and insulated. When force acts on the sensor layer 30J, the particles 36 come into contact with each other. As a result, the resistance of the sensor layer 30J decreases, and the common electrode 40 and the array electrode 20 are electrically coupled. Therefore, a current flows from the common electrode 40 to the array electrode 20. As the force increases, the number of particles 36 in contact with each other increases, and the resistance of the sensor layer 30J further decreases. As a result, the amount of current flowing from the common electrode 40 to the array electrode 20 also increases.

The lengths of the protrusion and the protruding portion in the stacking direction are not necessarily equal. In other words, the lengths of the protrusion and the protruding portion in the stacking direction may be appropriately changed. All the protrusions and the protruding portions are not necessarily made of the same material. In other words, protrusions (or protruding portions) made of different materials may be provided together.

The top end surface of the protrusion and the protruding portion according to the present disclosure is not limited to a flat surface. The top end surface may have a recessed or protruding shape to increase the coefficient of friction, and the shape is not particularly limited.

What is claimed is:

1. A load detection device comprising:
a force detector and an elastic deformation part disposed in order in a first direction, wherein
the force detector comprises:
an array substrate provided with a plurality of array electrodes on a first surface facing the first direction; and
a sensor layer facing the array electrodes,
the array electrodes are arrayed in a second direction intersecting the first direction and a third direction intersecting both the first direction and the second direction,
the elastic deformation part includes a plurality of protrusions having a rectangular sectional shape along the first direction and arrayed in the second direction and the third direction,
the protrusions are each disposed to overlap at least two or more of the array electrodes arrayed in the second direction and at least two or more of the array electrodes arrayed in the third direction when viewed from the first direction, and
the protrusions are each spaced apart from the other protrusions disposed in the second direction and the third direction.

2. The load detection device according to claim 1, wherein
the elastic deformation part includes an elastic deformation body having a plate shape and extending in a planar direction parallel to the second direction and the third direction, and
an end of the protrusion in the first direction or an end of the protrusion in an opposite direction of the first direction is continuous with the elastic deformation body.

3. The load detection device according to claim 2, wherein
the elastic deformation body has a plurality of through holes passing through the elastic deformation body in the first direction, and
at least some of the through holes overlap a gap formed between the protrusions when viewed from the first direction.

4. The load detection device according to claim 1, wherein
the elastic deformation part includes the protrusions alone, and
the protrusions are independent of each other.

5. A load detection device comprising:
a force detector and an elastic deformation part disposed in order in a first direction, wherein
the force detector comprises:
an array substrate provided with a plurality of array electrodes on a first surface facing the first direction; and
a sensor layer facing the array electrodes,
the array electrodes are arrayed in a second direction intersecting the first direction and a third direction intersecting both the first direction and the second direction,
the elastic deformation part comprises:
a plurality of first walls extending in the second direction and arrayed in the third direction; and
a plurality of second walls extending in the third direction and arrayed in the second direction,
the elastic deformation part has a grid shape by the first walls and the second walls intersecting each other,
a portion where the first wall and the second wall intersect is an intersection,
a portion of the first wall positioned between the intersections is a first protruding portion,
a portion of the second wall positioned between the intersections is a second protruding portion,
the first protruding portion has a rectangular sectional shape taken along a virtual plane extending in the first direction and the third direction and is disposed to overlap at least two or more of the array electrodes arrayed in the third direction when viewed from the first direction,
the second protruding portion has a rectangular sectional shape taken along a virtual plane extending in the first direction and the second direction and is disposed to overlap at least two or more of the array electrodes arrayed in the second direction when viewed from the first direction,
the first protruding portion is spaced apart from the other first protruding portions disposed in the third direction, and
the second protruding portion is spaced apart from the other second protruding portions disposed in the second direction.
